(19) United States
(12) Patent Application Publication
(10) Pub. No.: US 2021/0299761 A1
(43) Pub. Date: Sep. 30, 2021

(54) POWER TOOL

(71) Applicant: MAKITA CORPORATION, Anjo-shi (JP)

(72) Inventors: Hidenori NAGASAKA, Anjo-shi (JP); Tomohiko IMAE, Anjo-shi (JP)

(73) Assignee: MAKITA CORPORATION, Anjo-shi (JP)

(21) Appl. No.: 17/150,528

(22) Filed: Jan. 15, 2021

(30) Foreign Application Priority Data
Mar. 25, 2020 (JP) 2020-055119

(51) Int. Cl. B23B 45/02; B25F 5/02

(52) U.S. Cl. CPC B23B 45/02; B25B 21/00; B25F 5/026

(57) ABSTRACT

A power tool has less work performance deterioration. The power tool includes a motor, a fan, a body extending in a front-rear direction and accommodating the motor and the fan, a grip extending downward from the body, a connector located frontward from the grip and extending downward from the body, a battery holder connected to a lower end of the grip and to a lower end of the connector, and an inverter board accommodated in the body to switch a current provided from a battery held by the battery holder to the motor.

### CROSS-REFERENCE TO RELATED APPLICATIONS

This application claims the benefit of priority to Japanese Patent Application No. 2020-055119, filed on Mar. 25, 2020, the entire contents of which are hereby incorporated by reference.

### BACKGROUND

### 1. Technical Field

The present disclosure relates to a power tool.

### 2. Description of the Background

In the technical field of power tools, a power tool including a motor and a controller is known as described in Japanese Unexamined Patent Application Publication No. 2017-100259.

### BRIEF SUMMARY

The motor is driven in response to an operation signal output from the controller. When a high current flows through the controller, the temperature of the controller may increase. To dissipate heat from the controller at such higher temperature, the output of the motor may be reduced or the motor may be stopped. This causes performance deterioration of the work using the power tool.

One or more aspects of the present disclosure are directed to a power tool with less work performance deterioration.

A first aspect of the present disclosure provides a power tool, including:

a motor;

a fan;

a body extending in a front-rear direction and accommodating the motor and the fan;

a grip extending downward from the body;

a connector located frontward from the grip and extending downward from the body;

a battery holder connected to a lower end of the grip and to a lower end of the connector; and
an inverter board accommodated in the body to switch a current provided from a battery held by the battery holder to the motor.

A second aspect of the present disclosure provides a power tool, including:

a motor;

a body extending in a front-rear direction and accommodating the motor;

a grip extending downward from the body;

a connector located frontward from the grip and extending downward from the body;

a battery holder connected to a lower end of the grip and to a lower end of the connector;

and

a lead wire at least partially accommodated in the connector and connecting the battery holder and the motor.

A third aspect of the present disclosure provides a power tool, including:

a motor including

a stator, and

a rotor arranged inside the stator, the rotor including a rotor shaft extending in a front-rear direction,

a power transmission assembly driven by the rotor, the power transmission assembly arranged in front of the rotor;

an output unit driven by the power transmission assembly;

a body accommodating the motor and the power transmission assembly, the body extending in a front-rear direction;

a grip extending downward from the body, the grip accommodating a switch body inside, the grip gripped by an operator;

a connector extending downward from the body, the connector arranged in front of the grip;

a battery holder connecting a lower portion of the grip and a lower portion of the connector;

a battery configured to be fixed to the battery holder; and

a lead wire passing inside the connector to supply electric power from the battery to the motor.

The power tool according to the above aspects of the present disclosure has less work performance deterioration.

### BRIEF DESCRIPTION OF DRAWINGS

FIG. 1 is a perspective view of a power tool according to an embodiment.

FIG. 2 is a cross-sectional view of the power tool according to the embodiment.

FIG. 3 is a block diagram of the power tool according to the embodiment.

FIG. 4 is a diagram describing wiring in the power tool according to the embodiment.

FIG. 5 is a diagram describing wiring in a power tool according to another embodiment.

### DETAILED DESCRIPTION

Although one or more embodiments of the present disclosure will now be described with reference to the drawings, the present disclosure is not limited to the embodiments. The components in the embodiments described below may be combined as appropriate. One or more components may be eliminated.

In the embodiments, the positional relationships between the components will be described using the directional terms such as right and left (or lateral), front and rear (or forward and backward), and up and down (or vertical). The terms indicate relative positions or directions with respect to the center of a power tool.

The power tool according to the embodiments is a vibration driver drill including a motor. In the embodiments, a direction parallel to a rotation axis AX of the motor is referred to as an axial direction for convenience. A direction radial from the rotation axis AX of the motor is referred to as a radial direction or radially for convenience. A direction about the rotation axis AX of the motor is referred to as a circumferential direction, circumferentially, or a rotation direction for convenience. A position nearer the rotation axis AX of the motor in the radial direction, or a radial direction toward the rotation axis AX of the motor, is referred to as radially inside or radially inward for convenience. A position farther from the rotation axis AX of the motor in the radial direction, or a radial direction away from the rotation axis AX of the motor, is referred to as radially outside or radially outward for convenience. In the embodiments, the axial direction corresponds to the front-rear direction.

### Overview of Power Tool

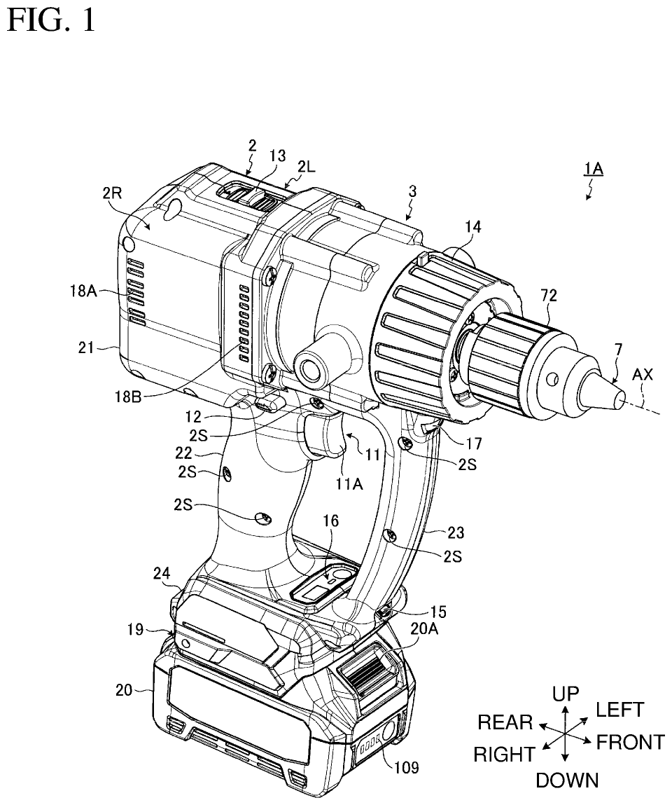

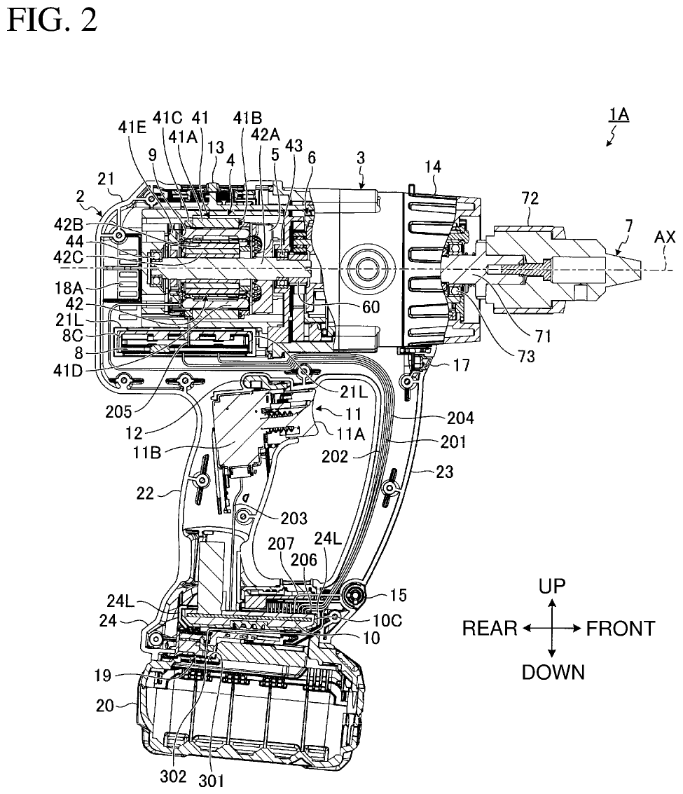

FIG. 1 is a perspective view of a power tool 1A according to an embodiment. FIG. 2 is a cross-sectional view of the power tool 1A according to the embodiment.

As shown in FIGS. 1 and 2, the power tool 1A includes a housing 2, a gear case 3, a motor 4, a fan 5, a power transmission assembly 6, an output unit 7, an inverter board 8, a sensor board 9, a control circuit board 10, a trigger switch 11, a forward-reverse switch lever 12, a speed switch lever 13, a mode change ring 14, a clutch dial 15, an interface panel 16, and a lamp 17.

The housing 2 is formed from a synthetic resin. The housing 2 includes a pair of housing halves. The housing 2 includes a left housing 2L and a right housing 2R located on the right of the left housing 2L. The left housing 2L and the right housing 2R are fastened together with multiple screws 2S.

The housing 2 includes a body 21, a grip 22, a connector 23, and a battery holder 24. The body 21 extends in the front-rear direction. The grip 22 extends downward from the body 21. The connector 23 is located frontward from the grip 22 and extends downward from the body 21. The battery holder 24 is connected to the lower end of the grip 22 and to the lower end of the connector 23.

The body 21 accommodates the motor 4 and the fan 5. The motor 4 and the fan 5 are located in an internal space of the body 21. The body 21 is integral with the grip 22 and the connector 23.

The body 21 has inlets 18A and outlets 18B. The inlets 18A and the outlets 18B are air vents to connect the internal space of the body 21 and the outside of the body 21. The outlets 18B are located frontward from the inlets 18A. The inlets 18A are located in the left and right portions of the body 21. The outlets 18B are located in the left and right portions of the body 21. As the fan 5 rotates, air outside the body 21 flows into the internal space of the body 21 through the inlets 18A. As the fan 5 rotates, air in the internal space of the body 21 flows out of the body 21 through the outlets 18B. In other words, air outside the body 21 flows into the internal space of the body 21 by flowing through the inlets 18A, and air in the internal space of the body 21 flows out of the body 21 by flowing through the outlets 18B.

The grip 22, which is gripped by an operator, protrudes downward from a lower portion of the body 21. The grip 22 has an internal space. The internal spaces of the body 21 and the grip 22 are connected to each other.

The connector 23 is located frontward from the grip 22. The connector 23 protrudes downward from the lower portion of the body 21. The connector 23 has an internal space. The internal spaces of the body 21 and the connector 23 are connected to each other.

The battery holder 24 holds a battery 20 with a battery mount 19 between them. The battery holder 24 is connected to the lower end of the grip 22 and to the lower end of the connector 23. The battery holder 24 has an internal space. The internal spaces of the battery holder 24, the grip 22, and the connector 23 are connected to one another.

The battery mount 19 is located in a lower portion of the battery holder 24. The battery 20 is attached to the battery mount 19. The battery 20 is detachable from the battery mount 19. The battery 20 is attached to the battery mount 19 to power the power tool 1A.

The battery 20 may be a secondary battery. The battery 20 in the embodiment may be a rechargeable lithium-ion battery. The battery 20 includes a release button 20A. The release button 20A is operable to release the battery 20 fastened on the battery mount 19. The release button 20A is located on the front surface of the battery 20.

The battery 20 includes a battery terminal 301. The battery mount 19 includes a tool terminal 302. The battery 20 attached to the battery mount 19 connects the battery terminal 301 and the tool terminal 302 to power the power tool 1A.

The gear case 3 is located in front of the body 21. The gear case 3 is formed from a metal such as aluminum. The body 21 has its front end connected to the rear end of the gear case 3. The gear case 3 is cylindrical. The gear case 3 accommodates the power transmission assembly 6 including multiple gears.

The motor 4 generates power to drive the output unit 7. The motor 4 is accommodated in the body 21. The motor 4 is driven by power provided from the battery 20. The motor 4 has the rotation axis AX extending in the front-rear direction.

The motor 4 is an inner-rotor direct-current (DC) brushless motor. The motor 4 includes a cylindrical stator 41 and a rotor 42 located inside the stator 41.

The stator 41 includes a stator core 41A, a front insulator 41B, a rear insulator 41C, multiple coils 41D, and a connection wire 41E. The stator core 41A includes multiple steel plates stacked on one another. The front insulator 41B is located in front of the stator core 41A. The rear insulator 41C is located behind the stator core 41A. The coils 41D are wound around the stator core 41A with the front insulator 41B and the rear insulator 41C between them. The connection wire 41E is supported by the rear insulator 41C. The connection wire 41E connects the coils 41D with one another.

The rotor 42 includes a rotor shaft 42A, a cylindrical rotor core 42B, and multiple permanent magnets 42C. The rotor core 42B surrounds the rotor shaft 42A. The permanent magnets 42C are held by the rotor core 42B. The rotor shaft 42A has a front portion rotatably supported by a bearing 43. The rotor shaft 42A has a rear portion rotatably supported by a bearing 44.

The fan 5 rotates to generate an airflow. The fan 5 is accommodated in the body 21. The fan 5 is located frontward from the stator core 41A. The fan 5 is mounted on a portion of the rotor shaft 42A between the stator core 41A and the bearing 43. The outlets 18B are located adjacent to the periphery of the fan 5.

The rotor shaft 42A receives a pinion gear 60 on its front end. The rotor shaft 42A is connected to the power transmission assembly 6 via the pinion gear 60.

The power transmission assembly 6 transmits rotational power generated by the motor 4 to the output unit 7. The output unit 7 is driven by rotational power transmitted from the motor 4 via the power transmission assembly 6. The power transmission assembly 6 includes a reduction mechanism, a vibration mechanism, and a clutch assembly. The reduction mechanism reduces rotation of the rotor shaft 42A and rotates the output unit 7 at a lower rotational speed than the rotor shaft 42A. The reduction mechanism includes a planetary gear assembly.

The output unit 7 is driven by rotational power transmitted from the motor 4 via the power transmission assembly 6. The output unit 7 at least partially protrudes frontward from the gear case 3. The output unit 7 receives a tip tool. The output unit 7 with the tip tool rotates.

The output unit 7 includes a spindle 71 and a chuck 72 to hold the tip tool. The spindle 71 is supported by a bearing 73 in a manner rotatable relative to the gear case 3. The spindle 71, which is supported by the bearing 73, is movable in the front-rear direction.

The chuck 72 can hold the tip tool. The chuck 72 is connected to the front of the spindle 71. The chuck 72 rotates as the spindle 71 rotates. The chuck 72 holding the tip tool rotates.

The inverter board 8 switches a current provided from the battery 20 held by the battery holder 24 to the motor 4. The inverter board 8 is accommodated in the body 21. The inverter board 8 is accommodated in a case 8C. The case 8C is held by a rib 21L in the body 21. The inverter board 8 includes multiple switching elements. The inverter board 8 is located below the motor 4 in the internal space of the body 21. The inverter board 8 is located rearward from the fan 5. In the front-rear direction, the inverter board 8 is at least partially located between the fan 5 and the inlets 18A. In the front-rear direction, the fan 5 is located frontward from the center of the inverter board 8, and the inlets 18A are located rearward from the center of the inverter board 8.

As the rotor shaft 42A rotates to rotate the fan 5, air outside the housing 2 flows into the internal space of the body 21 through the inlets 18A. The air flowing into the internal space of the body 21 comes in contact with the motor 4 and the inverter board 8 to cool the motor 4 and the inverter board 8 and flows out of the housing 2 through the outlets 18B.

The sensor board 9 detects rotation of the motor 4. The sensor board 9 is accommodated in the body 21. The sensor board 9 is supported by the rear insulator 41C. The sensor board 9 includes multiple magnetic sensors. The sensor board 9 is located rearward from the stator core 41A. The sensor board 9 outputs a detection signal to the control circuit board 10.

The control circuit board 10 outputs a control signal for controlling the power tool 1A. The control circuit board 10 includes a microcomputer. The control circuit board 10 is accommodated in the battery holder 24. The control circuit board 10 is accommodated in a case 10C. The case 10C is held by a rib 24L in the battery holder 24. The control circuit board 10 outputs a control signal for controlling the switching elements in the inverter board 8. The control circuit board 10 is accommodated in the battery holder 24.

The trigger switch 11 is located on the grip 22. The trigger switch 11 is operable to drive the motor 4. The trigger switch 11 includes a trigger 11A and a switch body 11B. The trigger 11A protrudes frontward from the upper front of the grip 22. The trigger 11A is operable by the operator. The operator holding the grip 22 by one (right or left) hand operates the trigger 11A with fingers. The switch body 11B is accommodated in the grip 22. In response to the trigger 11A being operated, the switch body 11B outputs an operation signal. The trigger switch 11 outputs the operation signal to the control circuit board 10.

In response to the operation signal from the trigger switch 11, the control circuit board 10 outputs a control signal for controlling the inverter board 8 to cause the battery 20 to power the motor 4. The motor 4 is driven by power provided from the battery 20 to the motor 4.

The forward-reverse switch lever 12 is located in an upper lateral portion of the grip 22. The forward-reverse switch lever 12 is operable by the operator. The forward-reverse switch lever 12 is operated to switch the rotation direction of the motor 4. The operator operates the forward-reverse switch lever 12 to switch the rotation direction of the motor 4 between forward and reverse. This switches the rotation direction of the output unit 7.

The speed switch lever 13 is located in an upper portion of the body 21. The speed switch lever 13 is operable by the operator to switch the rotational speed of the output unit 7. The operator operates the speed switch lever 13 to switch the rotational speed of the output unit 7 between a first speed and a second speed higher than the first speed.

The mode change ring 14 is located in front of the gear case 3. The mode change ring 14 is operable by the operator to switch the operation mode of the power tool 1A.

The operation mode of the power tool 1A includes a vibration mode and a non-vibration mode. In the vibration mode, the output unit 7 vibrates in the front-rear direction. In the non-vibration mode, the output unit 7 does not vibrate in the front-rear direction. The non-vibration mode includes a drill mode and a clutch mode. In the drill mode, power transmission to the output unit 7 is enabled independently of a rotation load on the output unit 7. In the clutch mode, power transmission to the output unit 7 is disabled depending on a rotation load on the output unit 7.

The clutch dial 15 is located on the lower front of the connector 23. The clutch dial 15 is operable by the operator. The clutch dial 15 outputs an operation signal to the control circuit board 10. In the clutch mode, the clutch dial 15 is operated to set a current value for stopping the motor 4. The current value indicates a rotation load on the output unit 7. In response to the rotation load on the output unit 7 reaching a value corresponding to the set current value, the motor 4 is stopped. This stops the rotation of the output unit 7.

The control circuit board 10 sets a current value for stopping the motor 4 in response to the operation signal output from the clutch dial 15. The control circuit board 10 detects the value of a current flowing through the motor 4 based on the voltage across a resister Rs (described later). When determining that the detected current value reaches the set current value, the control circuit board 10 stops the motor 4.

The flat interface panel 16 is located in the battery holder 24. The interface panel 16 includes a display and an operation unit. In response to the clutch dial 15 being operated, a set current value appears on the display of the interface panel 16.

The interface panel 16 is located on the upper surface of the battery holder 24. The interface panel 16 is located between the grip 22 and the connector 23 in the front-rear direction. In other words, the interface panel 16 is located in an inner space defined by the grip 22, the connector 23, and the battery holder 24.

The lamp 17 is located on the upper front of the grip 22. The lamp 17 emits illumination light that illuminates ahead of the power tool 1A. The lamp 17 includes, for example, a light-emitting diode (LED).

### Control System

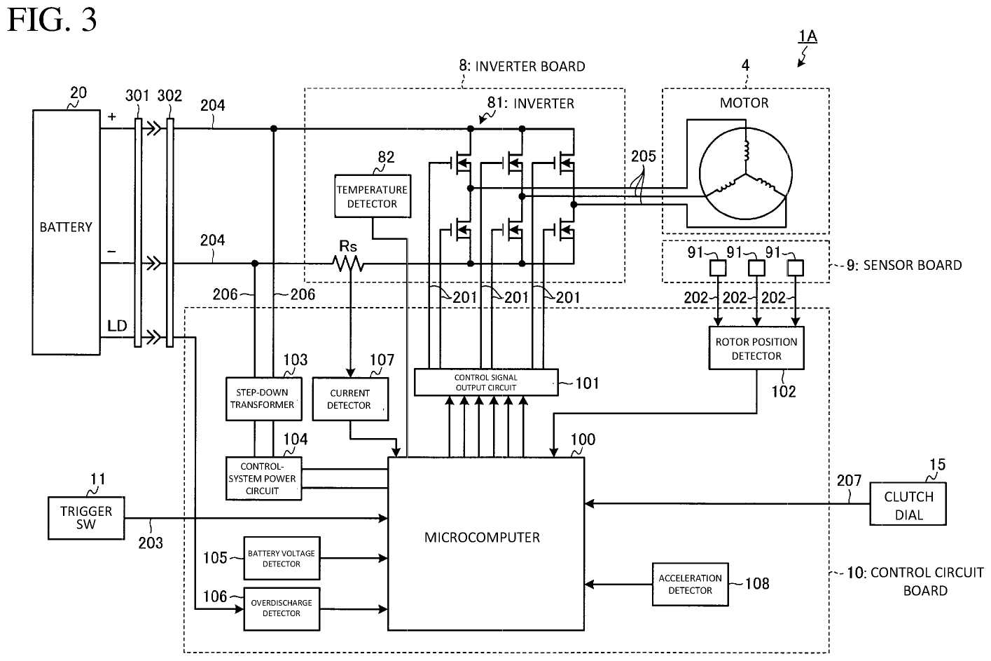

FIG. 3 is a block diagram of the power tool 1A according to the embodiment. As shown in FIG. 3, the power tool 1A includes the motor 4, the inverter board 8, the sensor board 9, the control circuit board 10, the trigger switch 11, and the battery 20.

The inverter board 8 includes an inverter 81 and a temperature detector 82.

The inverter 81 includes multiple switching elements. The switching elements each switch a current provided from the battery 20 to a corresponding coil 41D in the motor 4.

The temperature detector 82 detects the temperature of each switching element included in the inverter 81. The temperature detector 82 transmits, to a microcomputer 100, a detection signal indicating the temperature of each switching element.

The sensor board 9 includes magnetic sensors 91. The magnetic sensors 91 detect the permanent magnets 42C in the rotor 42 to detect rotation of the rotor 42. Each magnetic sensor 91 transmits a detection signal to the microcomputer 100.

The control circuit board 10 includes the microcomputer 100 serving as a controller, a control signal output circuit 101, a rotor position detector 102, a step-down transformer 103, a control-system power circuit 104, a battery voltage detector 105, an overdischarge detector 106, a current detector 107, and an acceleration detector 108.

The acceleration detector 108 detects a sudden movement of the power tool 1A. The entire power tool 1A may, for example, suddenly rotate when the output unit 7 stops rotating during work using the power tool 1A. The acceleration detector 108 detects such sudden rotation (sudden movement) of the power tool 1A. The acceleration detector 108 transmits, to the microcomputer 100, a detection signal indicating an acceleration caused by the sudden movement of the power tool 1A.

The step-down transformer 103 is connected to the battery 20 with lead wires 206. The step-down transformer 103 lowers a voltage provided from the battery 20.

The control-system power circuit 104 transforms an output voltage from the step-down transformer 103 to an operating voltage of the microcomputer 100 (e.g., 5 V) to power the microcomputer 100. The trigger switch 11 is located at a position different from the position of lead wires 204 for carrying a current between the battery 20 and the motor 4. The microcomputer 100 receives the operation signal from the trigger switch 11. The microcomputer 100 controls the motor 4 in response to the operation signal from the trigger switch 11.

The battery voltage detector 105 detects the voltage across the battery 20. The battery voltage detector 105 transmits, to the microcomputer 100, a detection signal indicating the voltage across the battery 20.

The overdischarge detector 106 is connected to an LD terminal, or a protection terminal, of the battery 20. The overdischarge detector 106 detects an overdischarge based on a voltage at the LD terminal. The overdischarge detector 106 transmits, to the microcomputer 100, a detection signal indicating an overdischarge at the LD terminal.

The current detector 107 detects a current flowing through the motor 4 based on the voltage across the resister Rs. The current detector 107 transmits, to the microcomputer 100, a detection signal indicating the current flowing through the motor 4.

The control signal output circuit 101 outputs a control signal for controlling, in response to a control signal from the microcomputer 100, turning on and off of the switching elements included in the inverter 81.

The rotor position detector 102 detects a position of the rotor 42 in the motor 4 based on an output voltage from each magnetic sensor 91 in the sensor board 9. The rotor position detector 102 transmits, to the microcomputer 100, a detection signal indicating the position of the rotor 42.

The microcomputer 100 causes the control signal output circuit 101 to output a control signal for controlling the inverter 81 in response to a detection signal output from the sensor board 9 and transmitted from the rotor position detector 102. The control signal output circuit 101 outputs the control signal to the inverter 81 to switch a current provided from the battery 20 to the coils 41D in the motor 4. When the motor 4 includes, for example, six coils 41D, the microcomputer 100 controls the switching elements in the inverter 81 to allow a first pair of coils 41D to serve as U-phase coils, a second pair of coils 41D to serve as V-phase coils, and a third pair of coils 41D to serve as W-phase coils. This rotates the rotor 42 in the motor 4, or a DC brushless motor, with the current provided from the battery 20.

As shown in FIG. 1, a battery indicator 109 is located in the battery 20. The battery indicator 109 notifies the operator of the battery power level of the battery 20.

### Wiring

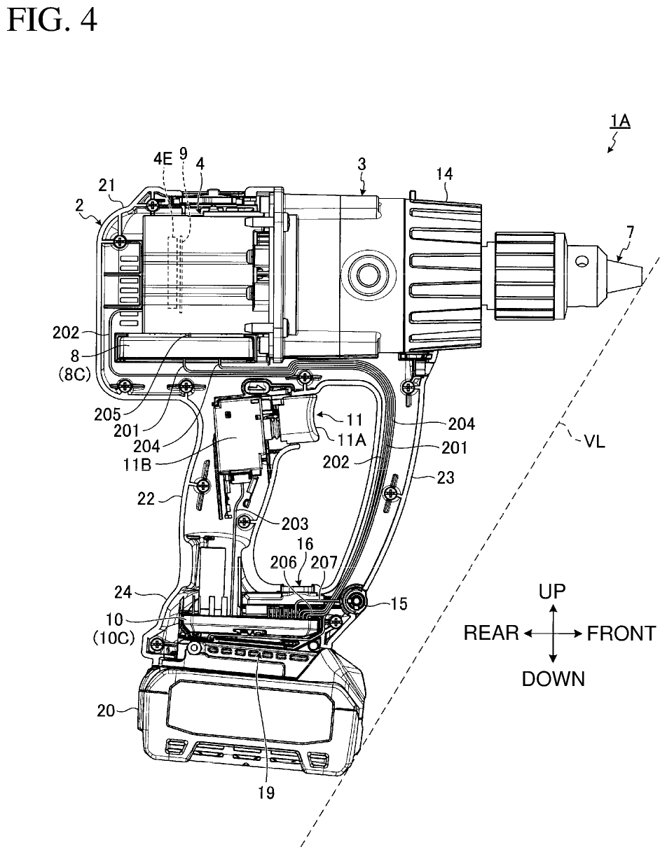

FIG. 4 is a diagram describing wiring in the power tool 1A according to the embodiment. As shown in FIGS. 2 to 4, the control signal output circuit 101 in the control circuit board 10 is connected to the inverter board 8 with first signal wires 201. The control signal output circuit 101 outputs a control signal for controlling the inverter board 8. The control signal output from the control signal output circuit 101 is transmitted to the inverter board 8 through the first signal wires 201. The first signal wires 201 are at least partially accommodated in the connector 23. The first signal wires 201 extend through the internal space of the connector 23.

The first signal wires 201 have their upper ends connected to the lower surface of the inverter board 8. The first signal wires 201 have their lower ends connected to the upper surface of the control circuit board 10. The first signal wires 201, which are connected to the lower surface of the inverter board 8, extend below the power transmission assembly 6. The first signal wires 201, which are routed forward below the power transmission assembly 6, extend through the internal space of the connector 23, and are connected to the upper surface of the control circuit board 10.

The rotor position detector 102 in the control circuit board 10 is connected to the sensor board 9 with second signal wires 202. The sensor board 9 outputs a detection signal indicating rotation of the motor 4. The detection signal output from the sensor board 9 is transmitted to the rotor position detector 102 through the second signal wires 202. The second signal wires 202 are at least partially accommodated in the connector 23. The second signal wires 202 extend through the internal space of the connector 23.

As described above, the sensor board 9 is located rearward from the stator core 41A in the motor 4. The second signal wires 202 have their upper ends connected to a lower portion of the sensor board 9. The second signal wires 202 extend behind and then below the inverter board 8, and are routed below the power transmission assembly 6. The second signal wires 202, which are routed forward below the power transmission assembly 6, extend through the internal space of the connector 23, and are connected to the upper surface of the control circuit board 10.

The microcomputer 100 in the control circuit board 10 and the switch body 11B are connected with a third signal wire 203. The switch body 11B outputs an operation signal for driving the motor 4. The operation signal output from the switch body 11B is transmitted to the microcomputer 100 through the third signal wire 203. The third signal wire 203 is at least partially accommodated in the grip 22. The third signal wire 203 extends through the internal space of the grip 22.

The third signal wire 203 has its upper end connected to a lower portion of the switch body 11B. The third signal wire 203 has its lower end connected to the upper surface of the control circuit board 10.

The microcomputer 100 in the control circuit board 10 is connected to the clutch dial 15 with a fourth signal wire 207. The clutch dial 15 outputs an operation signal for setting a current value for stopping the motor 4. The operation signal output from the clutch dial 15 is transmitted to the microcomputer 100 through the fourth signal wire 207. The fourth signal wire 207 is at least partially accommodated in the battery holder 24. The fourth signal wire 207 extends through the internal space of the battery holder 24.

The fourth signal wire 207 has its first end connected to the clutch dial 15. The fourth signal wire 207 has its second end connected to the upper surface of the control circuit board 10.

The battery terminal 301 and the tool terminal 302 are connectable to each other. The lead wires 204, carrying a current provided from the battery holder 24 to the motor 4, are connected to the tool terminal 302.

The lead wires 204 are at least partially accommodated in the connector 23. A drive current provided to the inverter board 8 through the lead wires 204 is then provided to the connection wire 41E in the motor 4 through lead wires 205.

Each of the lead wires 206 is branched from a lower portion of the corresponding lead wire 204. The battery 20 (tool terminal 302) and the step-down transformer 103 in the control circuit board 10 are connected with the lead wires 206. The battery 20 outputs a drive current to drive the motor 4. The drive current output from the battery 20 is provided to the step-down transformer 103 through the lead wires 206.

The lead wires 204 have their upper ends connected to the lower surface of the inverter board 8. The lead wires 204 have their lower ends connected to the tool terminal 302. The lead wires 205 have their upper ends connected to the coils 41D (connection wire 41E). The lead wires 205 have their lower ends connected to the upper surface of the inverter board 8. The lead wires 204, connected to the lower surface of the inverter board 8, extend below the power transmission assembly 6. The lead wires 204, which are routed forward below the power transmission assembly 6, extend through the internal space of the connector 23, and are connected to the tool terminal 302 in the battery mount 19.

As described above, the inverter board 8 in the embodiment is accommodated in the body 21. The body 21 accommodates the motor 4 and the fan 5 for cooling the motor 4. As the fan 5 rotates, air flows over the surface of the motor 4 to cool the motor 4. In the present embodiment, as the fan 5 rotates, air also flows over the surface of the inverter board 8 in addition to the motor 4 to cool the inverter board 8. When a high current flows through the inverter board 8, the temperature of the inverter board 8 may increase. In the present embodiment, the inverter board 8 is cooled to reduce an increase in the temperature of the inverter board 8.

To dissipate heat from the inverter board 8 at higher temperature, the output of the motor 4 may be reduced or the motor 4 may be stopped. This causes performance deterioration of the work using the power tool 1A. In the present embodiment, the inverter board 8 is less likely to reach high temperature although a high current flows through the inverter board 8, and has less performance deterioration of the work using the power tool 1A.

The inverter board 8 is at least partially located between the fan 5 and the inlets 18A. In this structure, air flowing into the internal space of the body 21 through the inlets 18A as the fan 5 rotates comes in contact with the surface of the inverter board 8, and flows toward the fan 5. This structure sufficiently cools the inverter board 8.

In the front-rear direction, the fan 5 is located frontward from the center of the inverter board 8, and the inlets 18A are located rearward from the center of the inverter board 8. In this structure, air flowing into the internal space of the body 21 through the inlets 18A is sufficiently in contact with the surface of the inverter board 8.

The inverter board 8 is located below the motor 4 in the body 21. The inverter board 8 and the motor 4 are located in parallel to avoid upsizing of the power tool 1A in the front-rear direction. Air flowing into the internal space of the body 21 through the inlets 18A is sufficiently in contact with the surfaces of the motor 4 and the inverter board 8. The first signal wires 201 and the second signal wires 202 connect the inverter board 8 and the control circuit board 10 without extending through the motor 4.

The control circuit board 10 is accommodated in the battery holder 24. The internal space of the battery holder 24 is thus used effectively. The body 21 does not accommodate the control circuit board 10 in the internal space, and thus can avoid being upsized.

The first signal wires 201, connecting the control circuit board 10 and the inverter board 8, extend through the internal space of the connector 23 rather than through the internal space of the grip 22. The internal space of the connector 23 is thus used effectively. The grip 22 does not accommodate the first signal wires 201 in the internal space, and thus can avoid being thicker.

The first signal wires 201 have their upper ends connected to the lower surface of the inverter board 8. The first signal wires 201 are thus less likely to be bent excessively.

The second signal wires 202, connecting the sensor board 9 and the control circuit board 10, extend through the internal space of the connector 23 rather than through the internal space of the grip 22. The internal space of the connector 23 is thus used effectively. The grip 22 does not accommodate the second signal wires 202 in the internal space, and thus can avoid being thicker.

The second signal wires 202 have their upper ends connected to the lower portion of the sensor board 9. The sensor board 9 is located rearward from the stator core 41A. The second signal wires 202 extend behind the inverter board 8. The second signal wires 202 are thus less likely to be bent excessively.

The third signal wire 203, connecting the trigger switch 11 and the control circuit board 10, extends through the internal space of the grip 22 rather than through the internal space of the connector 23. This structure enables the shorter third signal wire 203.

The lead wires 204, connecting the battery holder 24 and the motor 4, extend through the internal space of the connector 23 rather than through the internal space of the grip 22. The internal space of the connector 23 is thus used effectively. The grip 22 does not accommodate the lead wires 204 in the internal space, and thus can avoid being thicker.

The lead wires 204 have their upper ends connected to the lower surface of the inverter board 8. The lead wires 204 are thus less likely to be bent excessively.

The lower end of the grip 22 and the lower end of the connector 23 are independently connected to the battery holder 24. This structure increases the strength of a lower portion of the housing 2.

As shown in FIG. 4, an imaginary line VL is defined to connect the front end of the output unit 7 and the lower front end of the battery 20. The clutch dial 15 is located rearward from the imaginary line VL. This structure reduces, for example, contact between the clutch dial 15 and a floor surface when the power tool 1A is placed on or falls to the floor surface. The clutch dial 15 is thus less likely to be damaged.

The interface panel 16 is located on the upper surface of the battery holder 24. The interface panel 16 is located between the grip 22 and the connector 23 in the front-rear direction. In other words, the interface panel 16 is located in the inner space defined by the grip 22, the connector 23, and the battery holder 24. The interface panel 16 is protected by the grip 22, the connector 23, and the battery holder 24, and is thus less likely to be damaged.

### OTHER EMBODIMENTS

In the above embodiment, the inverter board 8 and the control circuit board 10 are independent of each other. The inverter board 8 is accommodated in the body 21, and the control circuit board 10 is accommodated in the battery holder 24. In some embodiments, the inverter board 8 may be integral with the control circuit board 10.

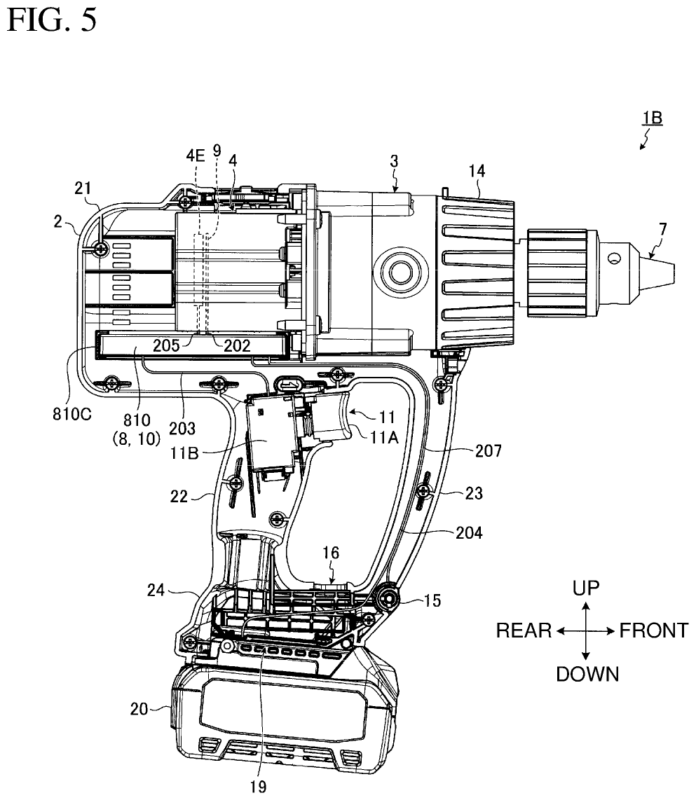

FIG. 5 is a diagram describing wiring in a power tool 1B according to another embodiment. As shown in FIG. 5, the body 21 may accommodate a controller board 810 including the inverter board 8 integral with the control circuit board 10. The controller board 810 is accommodated in a case 810C. In the example shown in FIG. 5, the first signal wires 201 are eliminated. The second signal wires 202 connect the lower portion of the sensor board 9 and the upper surface of the controller board 810. The third signal wire 203 connects the upper portion of the switch body 11B and the lower surface of the controller board 810. The lead wires 204 connect the lower surface of the controller board 810 and the battery mount 19. The lead wires 205 connect the upper surface of the controller board 810 and the coils 41D (connection wire 41E).

In the above embodiment, as the fan 5 rotates, air outside the body 21 flows into the internal space of the body 21 through the inlets 18A. In some embodiments, as the fan 5 rotates, air outside the body 21 may flow into the internal space of the body 21 through the outlets 18B, and flows out of the body 21 through the inlets 18A. In this case, the outlets 18B may serve as inlets, and the inlets 18A may serve as outlets. In some embodiments, the fan 5 may be located rearward from the center of the inverter board 8 in the front-rear direction. The fan 5 may be located, for example, rearward from the stator core 41A.

The power tool according to each of the above embodiments is a vibration driver drill. The power tool is not limited to a vibration driver drill, but may be a driver drill, an angle drill, an impact driver, a hammer, a hammer drill, or a reciprocating saw.

### REFERENCE SIGNS LIST

1A power tool
1B power tool
2 housing
2L left housing
2R right housing
2S screw
3 gear case
4 motor
5 fan
6 power transmission assembly
7 output unit
8 inverter board
8C case
9 sensor board
10 control circuit board
10C case
11 trigger switch
11A trigger
11B switch body
12 forward-reverse switch lever
13 speed switch lever
14 mode change ring
15 clutch dial
16 interface panel
17 lamp
18A inlet
18B outlet
19 battery mount
20 battery
20A release button
21 body
21L rib
22 grip
23 connector
24 battery holder
24L rib
41 stator
41A stator core
41B front insulator
41C rear insulator
41D coil
41E connection wire
42 rotor
42A rotor shaft
42B rotor core
42C permanent magnet
43 bearing
44 bearing
60 pinion gear
71 spindle
72 chuck
73 bearing
81 inverter
82 temperature detector
91 magnetic sensor
100 microcomputer
101 control signal output circuit
102 rotor position detector
103 step-down transformer
104 control-system power circuit
105 battery voltage detector
106 overdischarge detector
107 current detector
108 acceleration detector
109 battery indicator
201 first signal wire
202 second signal wire
203 third signal wire
204 lead wire
205 lead wire
206 lead wire
207 fourth signal wire
301 battery terminal
302 tool terminal
810 controller board
810C case
AX rotation axis
VL imaginary line

What is claimed is:

1. A power tool, comprising:
a motor;
a fan;
a body extending in a front-rear direction and accommodating the motor and the fan;
a grip extending downward from the body;
a connector located frontward from the grip and extending downward from the body;
a battery holder connected to a lower end of the grip and to a lower end of the connector; and
an inverter board accommodated in the body to switch a current provided from a battery held by the battery holder to the motor.

2. The power tool according to claim 1, wherein
the body has an air vent connecting an internal space of the body and an outside of the body, and
the inverter board is at least partially located between the fan and the air vent.

3. The power tool according to claim 2, wherein
the air vent includes
an inlet to allow an airflow from the outside to the internal space in response to rotation of the fan, and
an outlet to allow an airflow from the internal space to the outside, and
the inverter board is at least partially located between the fan and the inlet.

4. The power tool according to claim 3, wherein
the fan is located frontward from a center of the inverter board in the front-rear direction, and the inlet is located rearward from the center of the inverter board in the front-rear direction.

5. The power tool according to claim 1, wherein
the inverter board is located below the motor in the body.

6. The power tool according to claim 1, further comprising:
a control circuit board accommodated in the battery holder to output a control signal for controlling a switching element in the inverter board.

7. The power tool according to claim 6, further comprising:
a first signal wire at least partially accommodated in the connector and connecting the control circuit board and the inverter board.

8. The power tool according to claim 7, wherein
the first signal wire is connected to a lower surface of the inverter board.

9. The power tool according to claim 6, further comprising:
a sensor board accommodated in the body to detect rotation of the motor; and
a second signal wire at least partially accommodated in the connector and connecting the sensor board and the control circuit board.

10. The power tool according to claim 9, wherein
the sensor board is located rearward from a stator core in the motor, and
the second signal wire extends behind the inverter board.

11. The power tool according to claim 6, further comprising:
a trigger switch located on the grip and operable to drive the motor; and
a third signal wire at least partially accommodated in the grip and connecting the trigger switch and the control circuit board.

12. The power tool according to claim 6, further comprising:
a lead wire configured to carry a current provided from the battery holder to the motor and connected to a lower surface of the inverter board.

13. The power tool according to claim 12, wherein
the lead wire is at least partially accommodated in the connector.

14. The power tool according to claim 1, further comprising:
a control circuit board accommodated in the body to output a control signal for controlling a switching element in the inverter board.

15. A power tool, comprising:
a motor;
a body extending in a front-rear direction and accommodating the motor;
a grip extending downward from the body;
a connector located frontward from the grip and extending downward from the body;
a battery holder connected to a lower end of the grip and a to lower end of the connector; and
a lead wire at least partially accommodated in the connector and connecting the battery holder and the motor.

16. The power tool according to claim 15, wherein
the lead wire extends up to the battery holder.

17. The power tool according to claim 16, wherein
the battery holder accommodates a control circuit board, and
the lead wire is connected to the control circuit board.

18. The power tool according to claim 2, wherein
the inverter board is located below the motor in the body.

19. The power tool according to claim 2, further comprising:
a control circuit board accommodated in the battery holder to output a control signal for controlling a switching element in the inverter board.

20. A power tool, comprising:
a motor including
a stator, and
a rotor arranged inside the stator, the rotor including a rotor shaft extending in a front-rear direction;
a power transmission assembly driven by the rotor, the power transmission assembly arranged in front of the rotor;
an output unit driven by the power transmission assembly;
a body accommodating the motor and the power transmission assembly, the body extending in a front-rear direction;
a grip extending downward from the body, the grip accommodating a switch body inside, the grip gripped by an operator;
a connector extending downward from the body, the connector arranged in front of the grip;
a battery holder connecting a lower portion of the grip and a lower portion of the connector;
a battery configured to be fixed to the battery holder; and
a lead wire passing inside the connector to supply electric power from the battery to the motor.
